(19) United States
(12) Patent Application Publication
(10) Pub. No.: US 2007/0263521 A1
(43) Pub. Date: Nov. 15, 2007

(54) Optical pickup and optical disk apparatus

(75) Inventors: Isao Ichimura, Tokyo (JP); Takashi Nakao, Tokyo (JP); Satoshi Hineno, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/801,294

(22) Filed: May 9, 2007

(30) Foreign Application Priority Data
May 12, 2006 (JP) JP2006-134192

(51) Int. Cl. G11B 7/00

(52) U.S. Cl. 369/112.16; 369/112.05

(57) ABSTRACT

An optical pickup is configured to emit a light beam to an optical disk having a plurality of recording layers and is configured to receive a reflection light beam obtained when the emitted light beam is reflected at a recording layer of the optical disk. The optical pickup includes an objective lens configured to focus the light beam emitted from a light source at a focused recording layer of the optical disk and receive the reflection light beam; a focusing lens configured to focus the reflection light beam received by the objective lens; and a stray-light removing element including the boundary surface and being configured to remove stray light from the reflection light beam by reflecting only the stray light included in the reflection light beam reflected at an unfocused recording layer at the boundary surface.

### CROSS REFERENCES TO RELATED APPLICATIONS

The present invention contains subject matter related to Japanese Patent Application JP 2006-134192 filed in the Japanese Patent Office on May 12, 2006, the entire contents of which are incorporated herein by reference.

### BACKGROUND OF THE INVENTION

1. Field of the Invention

The present invention relates to an optical pickup and an optical disk apparatus and, more specifically, relates to an optical pickup and an optical disk apparatus that support optical disks having a plurality of recording layers.

2. Description of the Related Art

Recently, “Blu-ray Disk (BD) (Trademark of Sony Corporation)” that employs a blue-violet semiconductor laser beam having a wavelength of approximately 405 nm and an objective lens having a numerical aperture of 0.85 has been put to practical use.

A BD has a large recording capacity of 25 GB, which is about 5 times greater than a known digital versatile disk (DVD). To further increase the recording capacity of BD, a multi-layer disk having a plurality of recording layers has been proposed (for example, refer to the following documents: N. Shida, T. Higuchi, Y. Hosoda, H. Miyoshi, A. Nakano, and K Tsuchiya, “Multi-Layer Read-Only-Memory Disk Applicable to Blu-ray Disk Standard Using a Photopolymer Sheet with a Recording Capacity of 100 GB,” Jpn. J. Appl. Phys. Vol. 43, pp. 4983 (2004); and K. Mishima, H. Inoue, M Aoshima, T. Komaki, H. Hirata, and H. Utsunomiya, “Inorganic Write-Once Disk with Quadruple Recording Layers for the Blu-ray Disc System,” Proc. SPIE Vol. 5069, pp. 90 (2003)).

The above-cited documents both draw attention to the possibility of a four-layer BD. In particular, N. Shida et al. (2004) describes a BD that is less affected by multiple reflection, which occurs in the plurality of recording layers in the BD and is reduced by providing interlayer materials (spacers) having different thicknesses for each of the four recording layers of the BD.

As a method of producing a BD, a method of forming spacers for a multi-layer disk with a film or a sheet and a method of forming spacers by carrying out spin coating with an ultraviolet-curable resin is employed. By employing such a method, a multi-layer disk having six, eight, or more recording layers can be produced.

However, when multiple recording layers are provided as described above, the light beam is reflected at not only the recording layer at which a light beam is focused (focused recording layer), but also at other recording layers (unfocused recording layers) adjacent to the focused recording layer. The light reflected at the focused recording layer enters a light-receiving element as stray light and interferes with light reflected from the focused recording layer (signal light), generating an interference pattern. As a result, the quality of the detected signal light is significantly degraded.

To reduce the effect of the stray light, it is efficient to prevent, as much as possible, the stray light from entering the light-receiving element. As a method of removing stray light, a method is proposed in which two wave plates each having two regions, i.e., a region that generates a +λ/4 phase difference and a region that generates a −λ/4 phase difference, are positioned in front and behind of the focal point of the signal light such that the region that generates a +λ/4 phase difference of one wave plate overlaps with the region that generates a −λ/4 phase difference of the other wave plate. In this way, the polarization directions of the signal light and the stray light differ, and the stray light can be removed on the basis of the polarization direction (refer to T. Ogata, “Multi-layer Disk Read-out Technology used Photonic Crystal,” Technical Digest of Optics Japan, 23aPD1 (2005)).

However, there is a problem with the stray light removal method described in T. Ogata (2005) in that the wave plates have to be composed of self-cloning photonic crystal, whose production process is complicated, and the two wave plates have to be positioned in a highly accurate manner.

The present invention has been conceived in light of the problems described above and provides an optical pickup and an optical disk apparatus that have simple structures and that reliably eliminate the effect of stray light on a multilayer optical disk.

### SUMMARY OF THE INVENTION

To solve the above-identified problems an optical pickup according to an embodiment of the present invention is configured to emit a light beam to an optical disk having a plurality of recording layers and configured to receive a reflection light beam obtained when the emitted light beam is reflected at a recording layer of the optical disk, the optical pickup including an objective lens configured to focus the light beam emitted from a light source at a focused recording layer of the optical disk and receive the reflection light beam; a focusing lens configured to focus the reflection light beam received by the objective lens; and a stray-light removing element configured to remove stray light from the reflection light beam by reflecting only the stray light included in the reflection light beam reflected at an unfocused recording layer at a boundary surface, the stray-light removing element including the boundary surface, the boundary surface being provided on a plane including an optical axis of the reflection light beam focused by the focusing lens and being provided a predetermined distance away from a focal point of a focused light beam obtained from the reflection light beam reflected at the focused recording layer.

Since the stray-light removing element is configured such that only stray light reflected at the unfocused layer of the reflection light beam reflected at the optical disk is reflected at the boundary surface, stray light can be reliably prevented from being incident on the light-receiving element.

An optical disk apparatus according to an embodiment of the present invention is configured to emit a light beam to an optical disk having a plurality of recording layers and configured to receive a reflection light beam obtained when the emitted light beam is reflected at a recording layer of the optical disk, the optical disk apparatus including an objective lens configured to focus the light beam emitted from a light source at a focused recording layer of the optical disk and receive the reflection light beam; a focusing lens configured to focus the reflection light beam received by the objective lens; and a stray-light removing element configured to remove stray light from the reflection light beam by reflecting only the stray light included in the reflection light beam reflected at an unfocused recording layer at a boundary surface, the stray-light removing element including the boundary surface, the boundary surface being provided on a plane including an optical axis of the reflection light beam focused by the focusing lens and being provided a predetermined distance away from a focal point of a focused light beam obtained from the reflection light beam reflected at the focused recording layer.

Since the stray-light removing element is configured such that only stray light reflected at the unfocused layer of the reflection light beam reflected at the optical disk is reflected at the boundary surface, stray light can be reliably prevented from being incident on the light-receiving element.

An optical pickup and an optical disk apparatus according to embodiments of the present invention each include an objective lens configured to focus the light beam emitted from a light source at a focused recording layer of the optical disk and receive the reflection light beam; a focusing lens configured to focus the reflection light beam received by the objective lens; and a stray-light removing element configured to remove stray light from the reflection light beam by reflecting only the stray light included in the reflection light beam reflected at an unfocused recording layer at a boundary surface, the stray-light removing element including the boundary surface, the boundary surface being provided on a plane including an optical axis of the reflection light beam focused by the focusing lens and being provided a predetermined distance away from a focal point of a focused light beam obtained from the reflection light beam reflected at the focused recording layer. Therefore, stray light can be reliably prevented from being incident on the light-receiving element because the stray-light removing element is configured such that only stray light reflected at the unfocused layer of the reflection light beam reflected at the optical disk is reflected at the boundary surface.

### BRIEF DESCRIPTION OF THE DRAWINGS

FIG. 1 is a schematic view illustrating the overall structure of an optical disk apparatus according to an embodiment of the present invention;

FIG. 2 is a schematic view illustrating an optical pickup employing a stray-light removing element according to an embodiment of the present invention;

FIG. 3 is a schematic view illustrating a spherical aberration compensation element installed in the optical pickup;

FIG. 4 is a schematic view illustrating the structure of a light-receiving element;

FIG. 5 is a schematic view illustrating a stray-light removing element according to an embodiment of the present invention;

FIG. 6 is a schematic view illustrating stray light generated by a light beam focused at an L1 layer being reflected at an L2 layer forward of the L1 layer;

FIG. 7 is a characteristic curve showing the intensity of detected light when a boundary surface is formed of a metal thin layer;

FIG. 8 is a characteristic curve showing the intensity of detected light when a boundary surface is formed of a dielectric material;

FIG. 9 is a schematic view illustrating stray light generated by a light beam focused at an L1 layer being reflected at an L0 layer behind the L1 layer;

FIG. 10 is a schematic view illustrating an optical pickup employing a stray-light removing element according to another embodiment of the present invention; and

FIG. 11 is a schematic view illustrating a stray-light removing element according to another embodiment of the present invention.

### DESCRIPTION OF THE PREFERRED EMBODIMENTS

Embodiments of the present invention will be described below with reference to the drawings.

### (1) Structure of Optical Disk Apparatus

### (1-1) Overall Structure of Optical Disk Apparatus

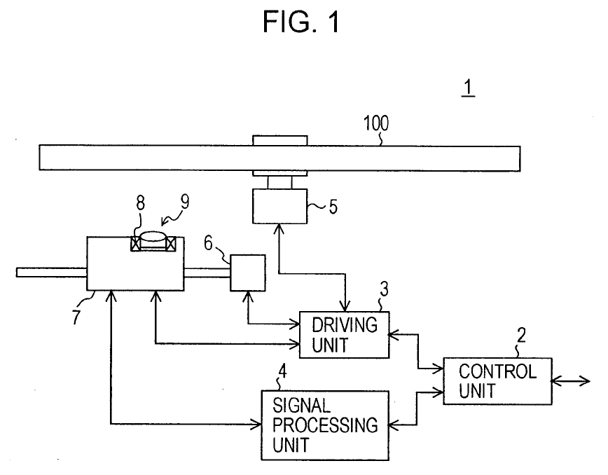

FIG. 1 illustrates an optical disk apparatus 1 according to an embodiment of the present invention. The optical disk apparatus 1 employs a stray-light removal prism and is capable of replaying an optical disk 100 constituted of a BD having three layers.

The optical disk apparatus 1 is entirely controlled by a control unit 2. When the optical disk apparatus 1 receives a replay instruction from an external device (not shown) with the optical disk 100 being loaded, the control unit 2 controls a driving unit 3 and a signal processing unit 4 to read out information stored on the optical disk 100.

According to the control of the control unit 2, the driving unit 3 rotates the optical disk 100 at a predetermined rotational speed by a spindle motor 5, moves an optical pickup 7 coarsely in a tracking direction, which is the radial direction of the optical disk 100, by a sled motor 6, and moves an objective lens 9 finely in a focusing direction, which is the direction toward or away from the optical disk 100, and in the tracking direction by a two-axis actuator 8.

At the same time, the signal processing unit 4 instructs the optical pickup 7 to emit a predetermined light beam from the via the objective lens 9 to a desired track on the optical disk 100, generates a replay signal on the basis of the result of detecting the light beam reflected at the optical disk 100, and sends the replay signal to an external device (not shown) via the control unit 2.

More specifically, the objective lens 9 of the optical pickup 7 focuses a light beam having a wavelength of approximately 405 nm, which corresponds to the BD system, at a recording layer of the optical disk 100 to be accessed (hereinafter this recording layer is referred to as a “focused recording layer”). The light beam reflected at the focused recording layer includes a recording signal component (hereinafter the reflected light beam is referred to as a “signal light beam”). The signal light beam is converged by the objective lens 9 and is photoelectrically converted to generate various signals that are supplied to the driving unit 3 and the signal processing unit 4.

The driving unit 3 drives the two-axis actuator 8 on the basis of focus error signals and tracking error signals from the optical pickup 7. The signal processing unit 4 carries out predetermined signal processing on the replay signal sent from the optical pickup 7 and then outputs the processed replay signal to an external unit via the control unit 2.

### (1-2) Structure of Optical Pickup

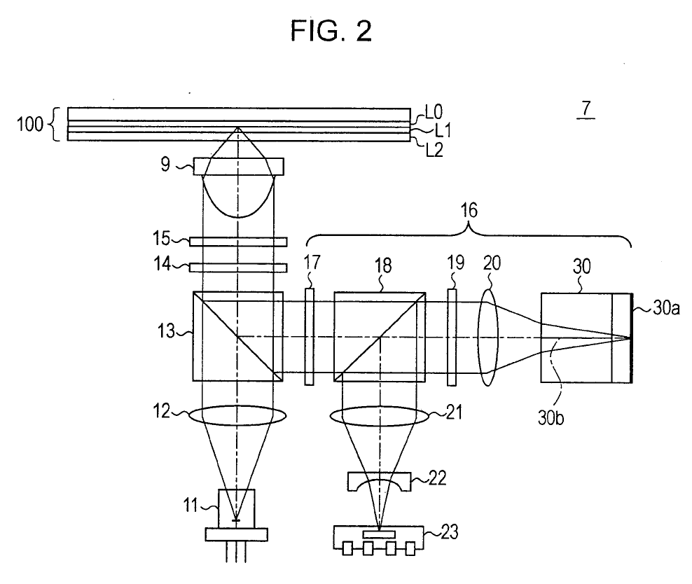

As illustrated in FIG. 2, in the optical pickup 7, a light beam having a wavelength of approximately 405 nm, which corresponds to the BD system, is emitted from a laser diode 11, which is the light source of the light beam. A collimating lens 12 converts the diverging light beam into a substantially collimated light beam. The substantially collimated light beam is incident on a polarizing beam splitter 13.

The polarizing beam splitter 13 allows the light beam from the collimating lens 12 to be transmitted through depending on the polarization direction of the light beam. The light beam transmitted through the polarizing beam splitter 13 is incident on a spherical-aberration compensation element 14. As the spherical-aberration compensation element 14, a liquid crystal phase plate such as that described in the following document may be employed: M. Iwasaki, M. Ogasawara, and S. Ohtaki, “A New Liquid Crystal Panel for Spherical Aberration Compensation,” Technical Digest of Optical Data Storage Topical Meeting, Santa Fe, pp. 103 (2001).

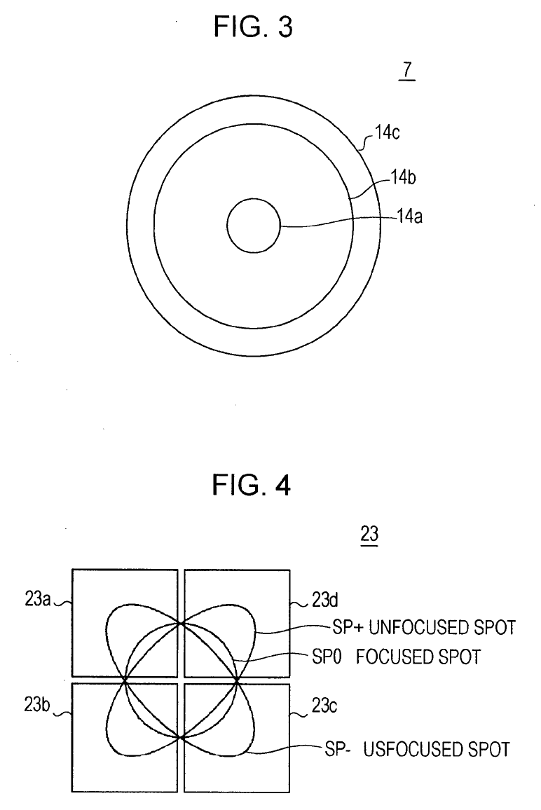

The spherical-aberration compensation element 14 constituted of such a liquid crystal phase panel includes concentric electrodes 14a, 14b, and 14c having different diameters, as illustrated in FIG. 3. Indium tin oxide (ITO) films having high resistance and optical transparency are interposed between the electrodes 14a, 14b, and 14c, and a desired voltage can be applied between electrodes opposing each other through a substrate in which liquid crystal is sealed. The spherical-aberration compensation element 14 generates, in accordance with the voltage applied to the electrodes 14a to 14c, a wave front that is substantially equivalent to the amount of compensation for the spherical aberration that is caused by a difference in the thickness of a cover layer (light-transmitting protective layer) of each BD.

Thus, the control unit 2 (refer to FIG. 1) of the optical disk apparatus 1 appropriately compensates for the aberration of a light beam generated in the cover layer by controlling the voltage applied to the electrodes 14a to 14c of the spherical-aberration compensation element 14 in accordance with the position of the recording layer of the optical disk 100 to be accessed. The spherical-aberration compensation element 14 is not limited to a liquid crystal phase plate and instead may be configured such that compensation for aberration is carried out by moving an optical element, such as an expander lens or a collimating lens, that has a function equivalent to the liquid crystal phase plate.

The light beam whose aberration has been compensated for by the spherical-aberration compensation element 14 of the optical pickup 7 is converted from a liner polarized light beam into a circularly polarized light beam by a quarter-wave plate 15. Then, circularly polarized light beam is gathered by the objective lens 9 having a numerical aperture (NA) of 0.85 and is incident on the recording layer of the optical disk 100.

The light beam reflected at the recording layer of the optical disk 100 (hereinafter referred to as a “reflection light beam”) is received by the objective lens 9, is linearly polarized by the quarter-wave plate 15 in a polarization direction orthogonal to the polarization direction of the light beam before being reflected, and is incident on the polarizing beam splitter 13. Due to the polarization direction, the linearly polarized reflection light beam is reflected at the polarizing beam splitter 13 in a right angle and enters a light-receiving system 16.

In the light-receiving system 16, the polarization direction of the reflected reflection light beam emitted from the polarizing beam splitter 13 is adjusted by a half-wave plate 17 so that the reflection light beam is transmitted through a polarizing beam splitter 18. The transmitted reflection light beam is circularly polarized again at the quarter-wave plate 19, is gathered by a focusing lens 20 having a NA of approximately 0.1, and is incident on a stray-light removing element 30.

The stray-light removing element 30 has a reflection surface 30a on one side. The reflection surface 30a is provided at a position that matches the focal point of the reflection light beam focused by the focusing lens 20. In this way, substantially 100% of the focused reflection light beam is reflected at the reflection surface 30a of the stray-light removing element 30, is converted into a diffused light beam, and is incident on the focusing lens 20. At this time, as described in detail below, the polarization direction of the stray light components included in the reflection light beam is changed by the stray-light removing element 30, and only the signal light beam that has been reflected at the focused recording layer is guided to a detection light path through a focusing lens 21, a cylindrical lens 22, and a light-receiving element 23.

In the light-receiving system 16, the signal light beam reflected at the reflection surface 30a of the stray-light removing element 30 is substantially collimated at the focusing lens 20. Then, the substantially collimated signal light beam is a linearly polarized at a quarter-wave plate 19 in a direction orthogonal to the polarization direction of the signal light beam before being reflected at the reflection surface 30a. The linearly polarized signal light beam is incident on the polarizing beam splitter 18. Due to the polarization direction, the signal light beam is reflected in a right angle at the polarizing beam splitter 18, which is a polarizing optical element, and forms an image on the light-receiving element 23 via the focusing lens 21 and the cylindrical lens 22. Then, the light-receiving element 23 generates various detection signals corresponding to the intensity of the received signal light beam.

Next, computation carried out on the various detection signals generated at the light-receiving element 23 will be described. Here, an astigmatism method is employed as a method of obtaining a focal-point error signal FES, and a phase difference method is employed as a method of obtaining a track error signal TES. However, instead, various other methods may be employed; for example, a knife edge method or a spot size method may be employed as a method of detecting a focal-point error signal, and a push-pull method a three-beam method, or differential push-pull method may be employed as a method detecting a track error signal.

As illustrated in FIG. 4, the light-receiving element 23 includes four light-receiving regions 23a, 23b, 23c, and 23d. Light incident on the light-receiving regions 23a, 23b, 23c, and 23d is photoelectrically converted into signals A, B, C, and D, respectively. Due to the effect of the focusing lens 21 and the cylindrical lens 22, when the received light beam is focused, a focused spot SPO, having a substantially circular intensity distribution, is formed on the light-receiving element 23, whereas when the light is not focused, an unfocused spot SP+ or SP−, having a substantially oval intensity distribution with a longitudinal axis in a diagonal direction, is formed on the light-receiving element 23.

Accordingly, by carrying out the following computation on the signals A to D, a focal-point error signal FES that has a so-called S-shaped waveform in which the signal level is zero when focused but is positive (+) or negative (−) when not focused.

FES=(A+C)−(B+D) (1)

The optical disk apparatus 1 according to this embodiment supports a three-layer BD-ROM disk, which is a multiple layer information recording medium. The optical disk apparatus 1 generates a track error signal TES corresponding to a play-only optical disk, such as the BD-ROM disk, that has predetermined information pit rows by employing the phase difference method applying the following expression.

TES=φ(A+C)−φ(B+D) (2)

Here, +represents the operator of the signal phase. A playback signal RFS is generated by adding the output signals A to D from the light-receiving regions 23a to 23d by applying the following expression.

RFS=A+B+C+D (3)

### (2) Stray Light Removal According to an Embodiment of the Present Invention

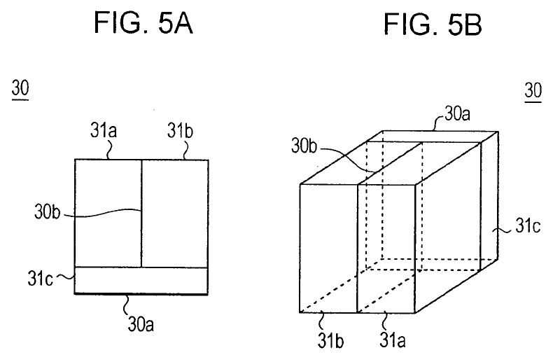

Next, removal of a stray light component from a reflection light beam by the stray-light removing element 30 according to an embodiment of the present invention will be described in detail. FIGS. 5A and 5B illustrate the structure of the stray-light removing element 30. The stray-light removing element 30 in constructed by bonding together three small cubic prisms 31a, 31b, and 31c that have the same indices of refraction.

The small cubic prisms 31a and 31b are bonded together with an optical material, such as an adhesive or a dielectric thin film that is transparent to the wavelength of the laser beam or a metal thin film that has an absorbing property. In this way, a boundary surface 30b consisting the above-mentioned optical material is formed between the small cubic prisms 31a and 31b. The index of refraction of the optical material constituting the boundary surface 30b is represented by n₁.

The cubic small cubic prism 31c is bonded to the small cubic prisms 31a and 31b with an optical material, such as an adhesive or a dielectric thin film that is transparent to the wavelength of the laser beam or a metal thin film that has an absorbing property. For bonding the small cubic prism 31c, an optical material having an index of refraction n₂ most similar to the index of refraction n_{g} of the three small cubic prisms 31a, 31b, and 31c is selected so as to suppress the reflectance of the transmitted light beam.

As described above, the reflection surface 30a on one side of the stray-light removing element 30 is provided at a position that matches the focal point of the reflection light beam focused by the focusing lens 20. The boundary surface 30b is positioned on a plane including the optical axis of the reflection light beam.

According to this embodiment, the NA of the objective lens 9 is set to 0.85; the NA of the focusing lens 21 is set to 0.1; and the three signal layers of the BD-ROM disk are referred to as an L0 layer, an L1 layer, and an L2 layer, from the layer farthest from the objective lens 9. FIG. 2 illustrates a light beam that is focused at the L1 layer being reflected at the L1 layer when the focal position of the objective lens 9 matches the L1 layer (i.e., the L1 layer is the focused layer).

As described above, a focused light beam reflected at the L1 layer, which is the focused layer (hereinafter this light beam is referred to as a “signal light beam”), is substantially collimated by the objective lens 9 and is focused at the reflection surface 30a of the stray-light removing element 30 by the focusing lens 20. Then, the signal light beam is reflected at the reflection surface 30a of the stray-light removing element 30, is diffused, and is incident on the focusing lens 20.

Since the signal light beam transmitted through the inside of the stray-light removing element 30 is focused at the reflection surface 30a, the signal light beam does not contact the boundary surface 30b interposed between the small cubic prisms 31a and 31b at any point in the optical path approaching the reflection surface 30a and the optical path moving away from the reflection surface 30a. Thus, the boundary surface 30b does not have any effect on the signal light beam focused at the reflection surface 30a. In addition, since the boundary surface 30b is provided away from the reflection surface 30a by a distance equal to the thickness of the small cubic prism 31c, even when the optical axis of the signal light is displaced, the boundary surface 30b does not have any effect on the signal light beam.

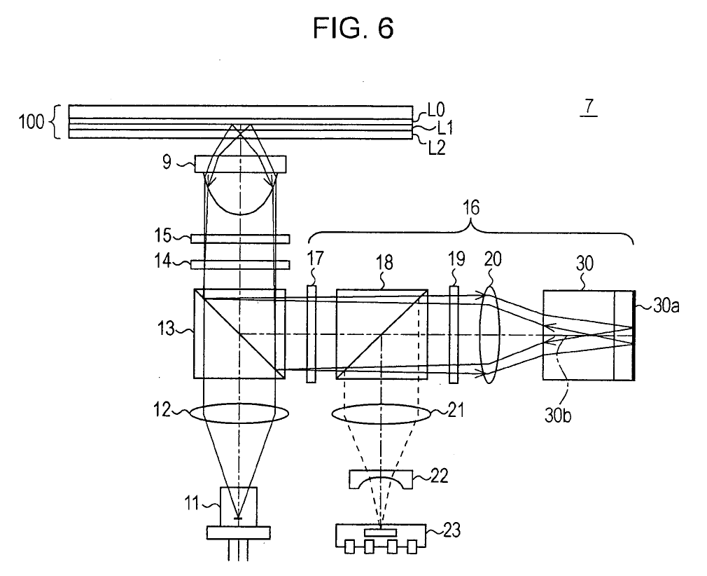

FIG. 6 illustrates stray light generated by a light beam that is focused at the L1 layer but is reflected at the L2 layer positioned forward of the L1 layer when the L1 layer is the focused layer. FIG. 6 does not illustrate the reflection light beam reflected at the L1 layer, i.e., does not illustrate the signal light beam. Since stray light generated at the L2 layer is reflected at a point forward of the focal point of the light beam, after passing through the objective lens 9, the stray light passes through the optical system of the optical pickup 7 as a gradually diffused light beam, not a collimated light beam, is converged at the focusing lens 20, and is incident on the stray-light removing element 30.

As described above, since the stray light is incident on the focusing lens 20 as a diffused light beam, the focal position of the focusing lens 20 is positioned behind the reflection surface 30a of the stray-light removing element 30. Thus, the stray light reflected at the reflection surface 30a is emitted from the stray-light removing element 30 after contacting the boundary surface 30b. At this time, the stray light is reflected, transmitted or absorbed at the boundary surface 30b.

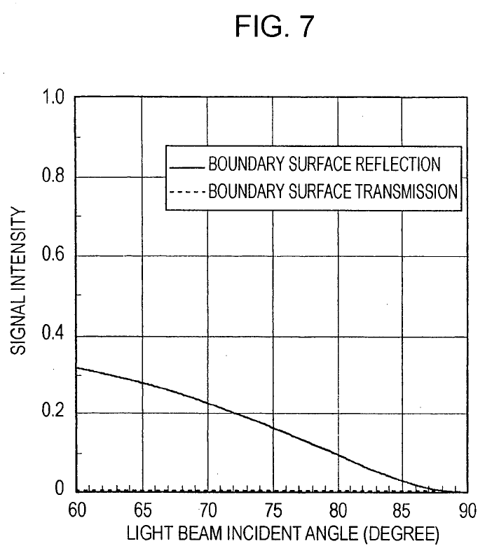

FIG. 7 illustrates the calculation results of the amount of light reflected at the polarizing beam splitter 18 and incident on the light-receiving element 23, among the light reflected at and transmitted through the boundary surface 30b, where a metal thin film of chromium (Cr) having a thickness of 50 nm is provided as the boundary surface 30b, the index of refraction n₁ of the boundary surface 30b is 2.05+2.90i (n₁=2.05+2.90i), and the index of refraction n_{g} of the small cubic prisms 31a, 31b, and 31c is 1.53 (n_{g}=1.53). More specifically, in FIG. 7, the horizontal axis represents the incident angle of the light beam to the boundary surface 30b, and the vertical axis represents the signal intensity of the light received by the light-receiving element 23. Moreover, the intensity of the light reflected at the reflection surface 30a is set to a standardized value of 1.

In this case, since the absorption at the boundary surface 30b composed of a metal thin film is great, most of the incident light is not transmitted through the boundary surface 30b but is reflected and absorbed.

More specifically, when the incident angle of the light beam to the boundary surface 30b is small, the light reflected at the boundary surface 30b is reflected at the polarizing beam splitter 18 and is incident on the light-receiving element 23. However, as the incident angle becomes greater, the polarization direction of the reflected light changes due to phase rotation, and the amount of light transmitted through the polarizing beam splitter 18 increases while the amount of light incident on the light-receiving element 23 decreases. In particular, when the reflection angle is 85° or greater, the amount of light guided to the light-receiving element 23 is significantly reduced.

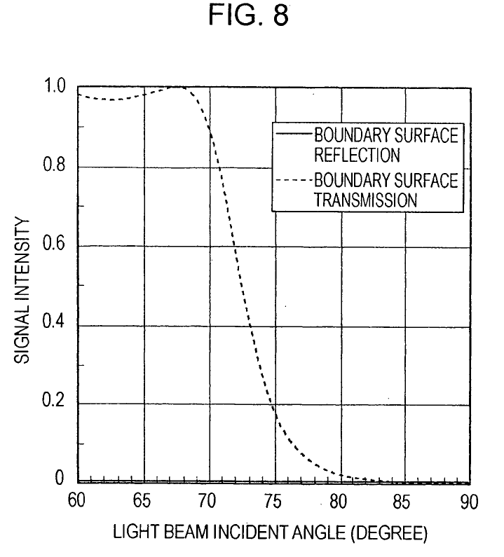

FIG. 8 illustrates the calculation results of the amount of light reflected at the polarizing beam splitter 18 and incident on the light-receiving element 23, among the light reflected at and transmitted through the boundary surface 30b, where a dielectric thin film or an adhesive layer having a thickness of 500 nm is provided as the boundary surface 30b, the index of refraction n₁ of the boundary surface 30b is 1.47 (n₁=1.47), and the index of refraction % of the small cubic prisms 31a, 31b, and 31c is 1.53 (n_{g}=1.53).

In this case, different from the case in which the boundary surface 30b is composed of a metal thin film (FIG. 7), light is not absorbed at the boundary surface 30b. Since the difference between the indices of refraction (i.e., the difference of n₁ and n_{g}) is small, when the incident angle is small, most of the light is transmitted through the boundary surface 30b, reflected at the polarizing beam splitter 18, and incident on the light-receiving element 23. When the incident angle of the light beam is greater than 70°, light is totally reflected at the boundary surface 30b. In this case also, since the polarization direction changes due to total reflection, the amount of light transmitted through the polarizing beam splitter 18 is increased, and the amount of light incident on the light-receiving element 23 is significantly reduced.

According to this embodiment, the numerical aperture of the focusing lens 20 is 0.1. Under this condition, the angle of the outermost light beam to the optical axis is approximately 6°. The angle of a light beam is 4° or smaller inside the stray-light removing element 30 due to refraction caused by air and the boundary surface of the optical material. Therefore, a light beam is incident on the boundary surface 30b of the stray-light removing element 30 at 86° or greater. Accordingly, as the calculation results shown in FIGS. 7 and 8, regardless of whichever optical material is used for forming the boundary surface 30b, most of the stray light is not incident on the light-receiving element 23, i.e., stray light is removed by the stray-light removing element 30.

Stray light generated at the L2 layer forward of the L1 layer, which is the focused layer, has been described above. Similarly, when the L0 layer is the focused layer and stray light is generated at the L1 layer or L2 layer forward of the L0 layer, the stray light, after being reflected at the reflection surface 30a of the stray-light removing element 30, is reflected at the boundary surface 30b so as to change the polarization direction of the stray-light or absorbs the reflected stray light at the boundary surface 30b. In this way, the stray light is prevented from being incident on the light-receiving element 23.

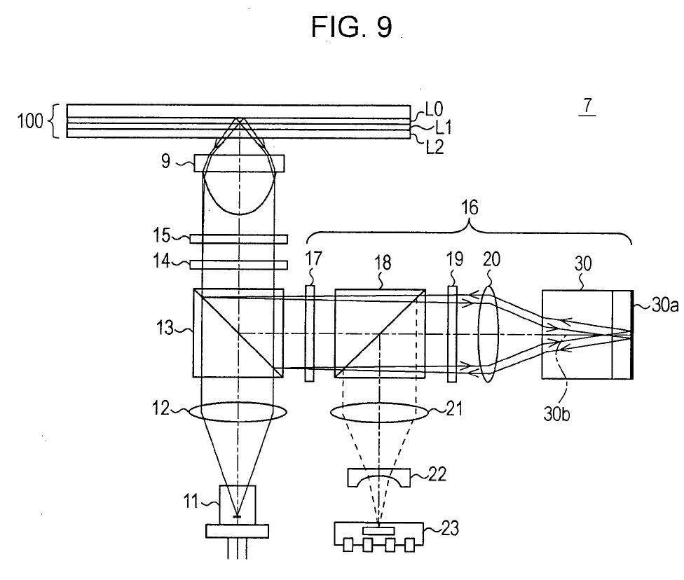

Similarly, stray light generated at a recording layer behind the focused recording layer is prevented from being incident on the light-receiving element 23 by reflecting, transmitting, or absorbing the stray light at the boundary surface 30b of the stray-light removing element 30. FIG. 9 illustrates stray light generated by a light beam that is focused at the L1 layer but is reflected at the L0 layer positioned behind the L1 layer when the L1 layer is the focused layer. FIG. 9 does not illustrate the reflection light beam reflected at the L1 layer, i.e., does not illustrate the signal light beam. Since stray light generated at the L0 layer is reflected at a point behind the focal point of the light beam, after passing through the objective lens 9, the stray light passes through the optical system of the optical pickup 7 as a gradually converged light beam, not a collimated light beam, is converged at the focusing lens 20, and is incident on the stray-light removing element 30.

As described above, since the stray light is incident on the focusing lens 20 as a converged light beam, the focal position of the focusing lens 20 is positioned forward of the reflection surface 30a of the stray-light removing element 30. Thus, the stray light incident on the removing element 30 contacts the boundary surface 30b before reaching the reflection surface 30a. In this case also, the stray-light removing element 30 prevents the stray light from being incident on the light-receiving element 23 by reflecting at the boundary surface 30b the stray light that has not yet reached the reflection surface 30a so as to change the polarization direction of the stray light or by absorbing the stray light, in accordance with the properties illustrated in FIG. 7 or 8.

### (3) Operation and Advantages

According to the above-described structure, in the optical pickup 7, the reflection light beam that has been reflected at the optical disk 100 is reflected at the reflection surface 30a of the stray-light removing element 30, is emitted to the polarizing beam splitter 18, is reflected at the polarizing beam splitter 18, and is incident on the light-receiving element 23.

The boundary surface 30b of the stray-light removing element 30 is provided away from the reflection surface 30a by a predetermined distance on the optical axis of the reflection light beam. When stray light generated by a light beam reflected at an unfocused recording layer of the optical disk 100 is focused by the focusing lens 20, the focal point of the stray light is positioned forward of or behind the reflection surface 30a. Therefore, the stray light is incident on the boundary surface 30b before or after being reflected at the reflection surface 30a.

The stray-light removing element 30 prevents stray-light from being incident on the light-receiving element 23 by transmitting the stray light through the polarizing beam splitter 18 as a result of changing the polarization direction of the stray light reflected at the boundary surface 30b and by absorbing the stray light at the boundary surface 30b.

According to the above-described structure, stray light that is incident on the light-receiving element 23 can be reliably removed by emitting only the stray light components of the reflection light beam to the boundary surface 30b of the stray-light removing element 30.

### (4) Another Embodiment

The above-described optical disk apparatus 1 according to an embodiment of the present invention supports the optical disk 100 having three recording layers. However, the present invention is not limited, and instead, an optical disk apparatus that supports an optical disk having a plurality of recording layers, e.g., two or four recording layers, is included in the scope of the present invention.

According to the above-described embodiment, the reflection surface 30a is formed at one side of the stray-light removing element 30 and reflects substantially 100% of the incident light so as to guide the reflected light to the light-receiving element 23. However, the present invention is not limited, and instead, the reflection surface 30a may be a half mirror in which part of the incident light is reflected at the reflection surface 30a and the remaining light is transmitted through the reflection surface 30a and a light-receiving element may be provided to light detected light transmitted through the reflection surface 30a.

According to the above-described embodiment, the boundary surface 30b is formed of a metal thin film, a dielectric thin film, or an adhesive layer. However, the present invention is not limited, and instead, the boundary surface 30b may be formed of a bumpy pattern that scatters light or a diffraction grating having high-order diffraction.

According to the above-described embodiment, the reflection light beam from the optical disk 100 is reflected at the reflection surface 30a of the stray-light removing element 30 and is incident on the light-receiving element 23, and the signal light beam is focused at the reflection surface 30a. In this way, stray light focused at a point in front of or behind the reflection surface 30a is reflected at the boundary surface 30b of the stray-light removing element 30 so as to change the phase or is absorbed, and the stray light incident on the light-receiving element 23 is removed. However, the present invention is not limited, and instead, the reflection light beam may be focused and boundaries may be provided in front of and behind the focal point of the reflection light beam.

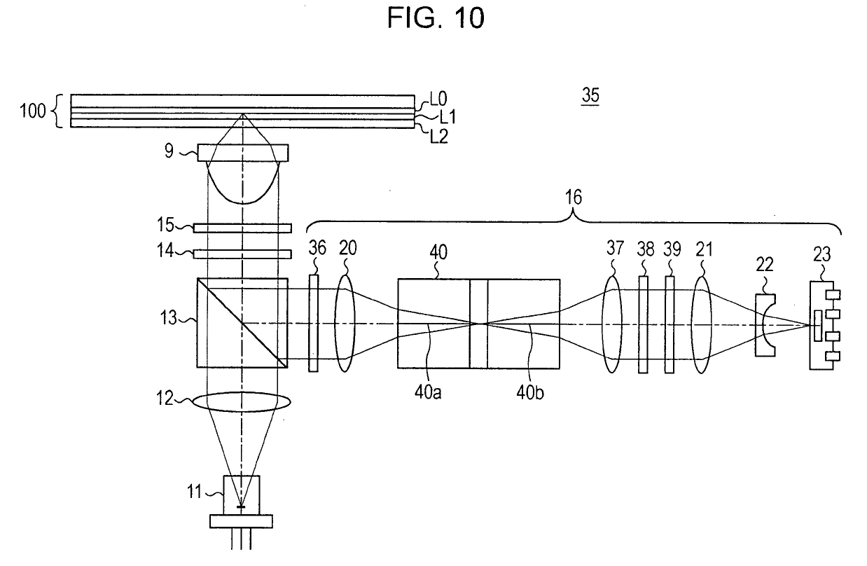

FIG. 10 illustrates an optical pickup 35 according to another embodiment of the present invention. The structure of the optical pickup 35 is the same as that of the optical pickup 7 illustrated in FIG. 2, except that the structure of the light-receiving system 16 differs. The components in FIG. 10 that corresponding to the components in FIG. 2 are represented by the same reference numeral as those in FIG. 7. A reflection light beam reflected at the polarizing beam splitter 13 and guided to the light-receiving system 16 is circularly polarized by a two-axis actuator 36 and is focused at the center area of a transmissive stray-light removing element 40 by the focusing lens 20 having an NA of approximately 0.1.

A reflection light beam diffused at the center area of the stray-light removing element 40 is collimated by the aperture limiting unit 37 and is incident on the focusing lens 21 through a quarter-wave plate 38 and an analyzer 39 in this order. The focusing lens 21 focuses the reflection light beam and forms an image on the light-receiving element 23 via the cylindrical lens 22. The light-receiving element 23 generates various detection signals depending on the intensity of the received reflection light beam.

At this time, stray light focused at a point in front of or behind the center area of the stray-light removing element 40 is reflected at the boundary surface 40a or 40b so as to change the phase or is absorbed. In this way, similar to the above-described stray-light removing element 30, the stray-light removing element 40 prevents stray light from being incident on the light-receiving element 23.

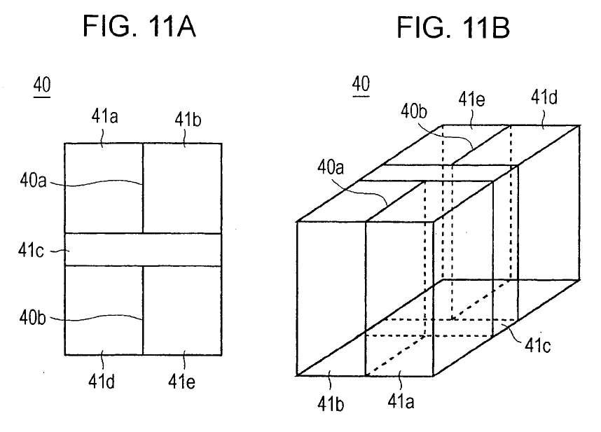

FIGS. 11A and 11B illustrate the structure of the stray-light removing element 40 that is formed by boding five small cubic prisms 41a, 41b, 41c, 41d, and 41e having the same index of refraction n_{g}.

By using an optical material, such as an adhesive or dielectric thin film transparent to the wavelength of the laser beam or such as a metal thin film having an absorbing property, the small cubic prism 41a and the small cubic prism 41b are bonded together, and the small cubic prism 41d and the small cubic prism 41e are bonded together. In this way, a boundary surface 40a is formed by the above-mentioned optical material between the small cubic prisms 41a and 41b, and a boundary surface 40b is formed by the above-mentioned optical material between the small cubic prisms 41d and 41e. The index of refraction of the optical material constituting the boundary surfaces 40a and 40b is represented by n₁.

The small cubic prism 41c is bonded to the small cubic prisms 41a and 41b and to the small cubic prisms 41d and 41e with an optical material, such as an adhesive or dielectric thin film transparent to the wavelength of the laser beam or such as a metal thin film having an absorbing property. To bond the small cubic prism 41c, an optical material having an index of refraction n₂ most similar to the index of refraction n_{g} of the three small cubic prisms 41a, 41b, 41d, and 41e is selected so as to suppress the reflectance of the transmitted light beam.

As described above, the center of the small cubic prism 41c at the center area of the stray-light removing element 40 is provided at a position that matches the focal point of the reflection light beam focused by the focusing lens 20. The boundary surfaces 40a and 40b are positioned at points in front of and behind the focal point on a plane including the optical axis of the reflection light beam.

In this way, stray light from a forward recording layer whose focal point is positioned behind the center area of the small cubic prism 41c is reflected, transmitted, or absorbed at the boundary surface 40b, whereas stray light from a rearward recording layer whose focal point is positioned forward of the center area of the small cubic prism 41c is reflected, transmitted, or absorbed at the boundary surface 40a.

The boundaries 40a and 40b, similar to the boundary surface 30b of the stray-light removing element 30, reflect stray light that is incident at a great angle on the boundaries 40a and 40b and change the phase of the stray light so that the stray light is not transmitted through the analyzer 39. In this way, stray light can be prevented from being incident on the light-receiving element 23.

In the above, a case in which the stray-light removing element 30 is employed to the optical pickup 7 of the optical disk apparatus 1 according to an embodiment of the present invention has been described. However, stray-light removing elements having various other structures may be included in the scope of the present invention. In other words, the stray-light removing element 30 does not necessarily have to be installed in the optical pickup 7, and the optical pickup 7 does not necessarily have to be installed in the optical disk apparatus 1.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup configured to emit a light beam to an optical disk having a plurality of recording layers and configured to receive a reflection light beam obtained when the emitted light beam is reflected at a recording layer of the optical disk, the optical pickup comprising:
an objective lens configured to focus the light beam emitted from a light source at a focused recording layer of the optical disk and receive the reflection light beam;
a focusing lens configured to focus the reflection light beam received by the objective lens; and
a stray-light removing element configured to remove stray light from the reflection light beam by reflecting only the stray light included in the reflection light beam reflected at an unfocused recording layer at a boundary surface, the stray-light removing element including the boundary surface, the boundary surface being provided on a plane including an optical axis of the reflection light beam focused by the focusing lens and being provided a predetermined distance away from a focal point of a focused light beam obtained from the reflection light beam reflected at the focused recording layer.

2. The optical pickup according to claim 1, further comprising:
a polarizing optical element configured to transmit or not transmit the reflection light beam emitted from the stray-light removing element through a light-receiving element on the basis of a polarization direction of the reflection light beam,
wherein the stray-light removing element prevents the stray light from being incident on the light-receiving element by changing the polarization direction of the stray light by reflecting the stray light at the boundary surface.

3. The optical pickup according to claim 1,
wherein the stray-light removing element includes a reflection surface near a focal point of the focused light beam focused by the focusing lens, the reflection surface being configured to reflect the reflection light beam, and
wherein the stray-light removing element removes the stray light from the reflection light beam by reflecting the stray light at the boundary surface before or after the stray light is reflected at the reflection surface.

4. The optical pickup according to claim 1,
wherein, the stray-light removing element includes two of the boundary surfaces, one of the boundary surfaces being provided at a position forward of the focal point of the focused light beam focused by the focusing lens and the other boundary surface being provided at a position behind the focal point of the focused light beam focused by the focusing lens, the boundary surfaces being provided on the plane including the optical axis of the reflection light beam.

5. The optical pickup according to claim 1,
wherein the boundary surface is formed of an optical material having an index of refraction smaller than the index of refraction of an optical material of the stray-light removing element in contact with the boundary surface.

6. The optical pickup according to claim 1,
wherein the boundary surface is formed of an optical thin film configured to absorb or reflect the reflection light beam.

7. The optical pickup according to claim 1,
wherein the boundary surface is formed of a bumpy pattern configured to scatter the reflection light beam.

8. The optical pickup according to claim 1,
wherein the boundary surface is formed of a diffraction grating configured to diffract the reflection light beam.

9. An optical disk apparatus configured to emit a light beam to an optical disk having a plurality of recording layers and configured to receive a reflection light beam obtained when the emitted light beam is reflected at a recording layer of the optical disk, the optical disk apparatus comprising:
an objective lens configured to focus the light beam emitted from a light source at a focused recording layer of the optical disk and receive the reflection light beam;
a focusing lens configured to focus the reflection light beam received by the objective lens; and
a stray-light removing element configured to remove stray light from the reflection light beam by reflecting only the stray light included in the reflection light beam reflected at an unfocused recording layer at a boundary surface, the stray-light removing element including the boundary surface, the boundary surface being provided on a plane including an optical axis of the reflection light beam focused by the focusing lens and being provided a predetermined distance away from a focal point of a focused light beam obtained from the reflection light beam reflected at the focused recording layer.

10. The optical disk apparatus according to claim 9, further comprising:
a polarizing optical element configured to transmit or not transmit the reflection light beam emitted from the stray-light removing element through a light-receiving element on the basis of a polarization direction of the reflection light beam,
wherein the stray-light removing element prevents the stray light from being incident on the light-receiving element by changing the polarization direction of the stray light by reflecting the stray light at the boundary surface.
